(19) United States
(12) Patent Application Publication
(10) Pub. No.: US 2026/0092553 A1
(43) Pub. Date: Apr. 2, 2026

(54) TWO-STROKE ENGINE

(71) Applicant: Andreas Stihl AG & Co. KG, Waiblingen (DE)

(72) Inventors: Simon Hummel, Filderstadt-Bonlanden (DE); Michael Grether, Waiblingen (DE); Lukas Dürrwächter, Esslingen (DE); Marvin Wahl, Waiblingen (DE)

(21) Appl. No.: 19/347,440

(22) Filed: Oct. 1, 2025

(30) Foreign Application Priority Data
Oct. 1, 2024 (DE) 10 2024 128 373.4

(51) Int. Cl. F02B 25/04; F02F 3/28

(52) U.S. Cl. CPC F02B 25/04; F02F 3/28

(57) ABSTRACT

A two-stroke engine has a cylinder in which a piston is mounted in a reciprocating manner. The piston delimits a combustion chamber in the cylinder. An air channel leads out at a cylinder bore of the cylinder via a channel opening. A transfer channel leads out at the cylinder bore via a transfer window and fluidically connects the crankcase interior to the combustion chamber in the region of the bottom dead center of the piston. The piston has a piston pocket connecting the air channel opening to the transfer window at least in the region of the top dead center. To ensure a sufficient fuel supply, the piston pocket has at least one section configured and arranged such that, during the downward stroke, a fluidic connection between the piston pocket and the air channel opening exists down to a crankshaft angle of at least 40° before bottom dead center.

### CROSS-REFERENCE TO RELATED APPLICATIONS

This application claims priority of German patent application no. 10 2024 128 373.4, filed Oct. 1, 2024, the entire content of which is incorporated herein by reference.

### BACKGROUND

US 2012/0060381 discloses a handheld working device with a two-stroke engine of the type in question. The fuel supply takes place via a carburetor depending on the negative pressure in the intake channel.

It has been found that, in known two-stroke engines, in particular in certain speed ranges, insufficient fuel supply can occur. This has been found in particular at high speeds.

### SUMMARY

It is an object of the disclosure to provide a two-stroke engine with which sufficient fuel supply can occur in all operating states.

This object is, for example, achieved via a two-stroke engine including: a cylinder; a piston mounted in the cylinder in a reciprocating manner, wherein the piston delimits a combustion chamber formed in the cylinder; a crankcase defining a crankcase interior and having a crankshaft mounted rotatably therein; the piston being configured to drive a crankshaft mounted rotatably in a crankcase in rotation; an intake channel which leads into the crankcase interior by way of an intake channel opening; an air channel which leads out at a cylinder bore by way of at least one air channel opening; at least one transfer channel which leads out at the cylinder bore of the cylinder by way of at least one transfer window and which fluidically connects the crankcase interior to the combustion chamber in a region of a bottom dead center of the piston; the piston having at least one piston pocket which connects the at least one air channel opening to the at least one transfer window at least in a region of a top dead center of the piston; a fuel supply unit for supplying fuel into the intake channel; and, the at least one piston pocket having at least one section configured and arranged such that, during a downward stroke of the piston, a fluidic connection between the at least one piston pocket and the at least one air channel opening exists down to a crankshaft angle (α) of at least 40° before the bottom dead center of the piston.

It has been found that the insufficient fuel supply can be caused by the fact that the pressure in the intake channel is too high in at least one speed range in at least one period of time. As a result, the pressure difference, required for the intake of fuel, between the fuel supply system and intake channel, in particular in fuel systems that operate with a slight overpressure or in a virtually pressure-free manner, does not exist under certain circumstances. It has been found that, in known two-stroke engines, this small pressure difference can occur before the time of an engine cycle at which the intake channel is connected to the crankcase interior via the intake channel opening, that is, in the region of the engine timing for opening of the intake channel opening.

In order for it to be possible to lower the pressure in the intake channel before the intake channel is connected to the crankcase interior via the intake channel opening, according to the disclosure, provision is made to maintain the connection of the piston pocket with the air channel opening for longer than usual during the downward stroke of the piston. It has been found that if the piston pocket is closed early during the downward stroke of the piston, relatively high pressure can prevail in the piston pocket. During the downward stroke of the piston, the transfer windows to the piston pocket are usually closed first and subsequently the air channel opening to the piston pocket is closed. The pressure that prevails in the air channel at this point in time prevails at the air channel opening. This may be the same pressure as the pressure in the intake channel.

The relatively high overpressure that can prevail in the piston pocket when the piston pocket is closed in known two-stroke engines during the downward stroke of the piston can result in a pressure rise in the air channel when the piston pocket is reopened to the air channel. This increased pressure can be transmitted into the intake channel for example via a fluidic connection of the intake channel and air channel.

The disclosure now provides that the fluidic connection of the air channel opening and piston pocket exists down to a crankshaft angle of at least 40° before bottom dead center. In the region of bottom dead center and even therebefore, approximately ambient pressure usually prevails in the air channel and in the intake channel. Since the connection between the piston pocket and air channel opening is maintained for longer than usual, the overpressure in the piston pocket can be gradually reduced early. When the piston pocket is reopened to the air channel during the subsequent upward stroke, the pressure in the air channel and in particular also the pressure in the intake channel is reduced as a result. This pressure reduction may be sufficient to lower the pressure level in the intake channel such that fuel can be supplied into the intake channel under slight pressure.

The pressure supply takes place in particular via a carburetor or via a fuel valve. The fuel supplied into the intake channel is in particular under slight pressure. In particular, the overpressure of the fuel amounts to at most 1 bar, in particular at most 500 mbar above atmospheric pressure. In particular, the overpressure of the fuel amounts to at most 200 mbar, in particular 50 mbar to 150 mbar above atmospheric pressure.

Fuel systems that meter the fuel under a very slight overpressure can have a simple construction. In particular, a fuel pump of the fuel system is driven by the rotating crankshaft of the two-stroke engine. This results in a simple construction. In particular, the two-stroke engine includes a carburetor and the fuel is drawn into the intake channel on account of the negative pressure in the intake channel. The carburetor may have an electrically actuated valve, in particular an electromagnetic valve, in order to additionally control the fuel supply. Alternatively, the two-stroke engine may have a fuel valve, for example an electromagnetic valve, which supplies the fuel.

The section of the fuel pocket that establishes the fluidic connection between the piston pocket and air channel opening serves only to allow pressure equalization between the piston pocket and air channel until a desired time during the downward stroke of the piston. To this end, the section has in particular a small flow cross section.

In particular, the intake channel and air channel are fluidically connected.

In particular, the intake channel and air channel are controlled via a common throttle element. In the region of the throttle element, the channels are connected fluidically together, at least outside of full load, in particular in the region of the throttle element.

The section has in particular a width which amounts to less than 50%, in particular less than 80% of the maximum width of the piston pocket. Both the width of the section and the width of the piston pocket are measured in a flat projection of the piston perpendicular to the longitudinal center axis of the cylinder bore. The width is measured in the peripheral direction of the piston and in the peripheral direction of the cylinder bore.

The section has in particular a height, measured parallel to the longitudinal center axis, which corresponds to at least 3%, in particular at least 5%, of a stroke of the piston.

The section is, in particular, not intended to change the engine timing for the connection of the piston pocket to the transfer windows during the upward stroke of the piston. In this regard, provision is made in particular for the section to lie in a peripheral region of the piston which does not overlap a transfer window in any piston position.

A simple configuration arises when the section extends at an upper edge of the piston pocket. In particular, the section is in the form of a groove.

The section forms in particular a pilot control groove. The section changes in particular the engine timing for the connection of the piston pocket and air channel, without changing the engine timing for the connection of the piston pocket to the transfer windows.

The flow cross section of the fluidic connection established by the section amounts in particular to less than 50%, in particular less than 80% of the maximum flow cross section of the connection of the piston pocket and air channel opening.

In particular, the at least one air channel opening and the at least one piston pocket are configured and arranged such that the fluidic connection between the at least one piston pocket and the at least one air channel opening is closed at a time during the downward stroke of the piston at which ambient pressure or a lower pressure than ambient pressure prevails in the air channel in at least one operating state, in particular at least under full load.

In particular, the fuel is supplied via a fuel valve. The fuel supply takes place, in particular in at least one operating state, at least partially at a time at which the intake channel opening is not connected to the crankcase interior.

The piston has in particular at least one piston ring groove. The piston pocket exhibits a spacing from the piston ring groove which is less than 8 mm, in particular less than 5 mm. The spacing is in this case measured parallel to the longitudinal center axis of the cylinder bore. The spacing is in particular as small as possible.

The two-stroke engine has in particular an air filter into which the intake channel and the air channel lead. In particular, the air for the operation of the two-stroke engine is drawn in via the air filter.

In particular, the intake channel and the air channel are connected fluidically together in a clean chamber of the air filter.

The intake channel and the air channel have, in particular downstream of the air filter, a connection via which the intake channel and the air channel are fluidically connected. In particular, the intake channel and the air channel have a common channel section in which a controllable throttle element is arranged, which controls the free flow cross section of the intake channel and air channel. In particular, the fluidic connection of the intake channel and air channel exists in the region of the controllable throttle element. In particular, the fluidic connection exists at least with the throttle element fully closed and/or only partially open. With the throttle element fully open, the fluidic connection of the intake channel and air channel can be closed by the throttle element. In particular, the air channel and intake channel are separated from one another by a partition wall. The throttle element is arranged in particular in an opening in the partition wall. In particular, in a fully open position, the throttle element closes the opening in the partition wall.

The fuel supply device is in particular a fuel valve. In particular, the fuel supply device is a fuel valve that operates with an overpressure of at most 1 bar, in particular at most 500 mbar, in particular at most 200 mbar, in particular 50 mbar to 150 mbar above atmospheric pressure.

### BRIEF DESCRIPTION OF DRAWINGS

The invention will now be described with reference to the drawings wherein:

FIG. 1 shows a schematic illustration of a two-stroke engine;

FIG. 2 shows a perspective illustration of a piston of the two-stroke engine from FIG. 1;

FIG. 3 shows a flat projection of the piston and cylinder bore of the two-stroke engine from FIG. 1 at bottom dead center of the piston;

FIG. 4 shows a partial flat projection as per FIG. 3 for an alternative embodiment of the piston of the two-stroke engine;

FIG. 5 shows a partial sectional illustration of the two-stroke engine in the region of the piston and air channel opening; and,

FIG. 6 shows a schematic diagram which shows a possible pressure profile in the intake channel in a two-stroke engine according to the prior art and in a two-stroke engine according to the disclosure.

### DETAILED DESCRIPTION

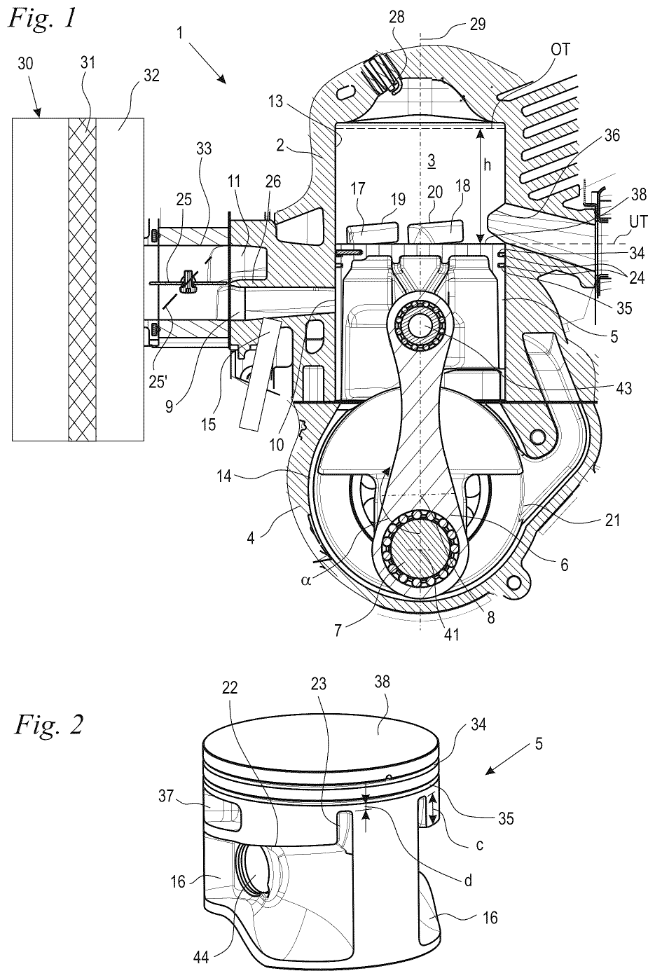

FIG. 1 schematically shows a two-stroke engine 1. The two-stroke engine 1 is in particular the drive engine in a working device, for example a chainsaw, an angle grinder, a brush cutter, a blower or the like. The working device may also be, for example, a lawnmower. The working device is in particular a handheld working device. In particular, the working device is a portable working device.

The two-stroke engine 1 includes a cylinder 2 in which a cylinder bore 13 is formed. The cylinder bore 13 has a longitudinal center axis 29. Formed in the cylinder bore 13 is a combustion chamber 3. A spark plug 28 projects into the combustion chamber 3. The combustion chamber 3 is delimited by a piston 5. The piston 5 is mounted in a reciprocating manner in the cylinder bore 13. The piston 5 drives, via a connecting rod 6, a crankshaft 7 that is mounted in a crankcase 4 so as to be rotatable about a rotational axis 8. The crankcase 4 has a crankcase interior 14.

In FIG. 1, the piston 5 is illustrated at its bottom dead center UT. At bottom dead center UT, the piston 5 exhibits its smallest spacing from the rotational axis 8 of the crankshaft 7. The bottom dead center UT forms one end position in the reciprocating movement of the piston 5. In the other end position of the piston 5, the piston 5 is at its top dead center OT. At top dead center OT, the piston 5 exhibits its maximum spacing from the rotational axis 8 of the crankshaft 7. Between bottom dead center UT and top dead center OT, the piston 5 executes a stroke h. The stroke h is measured parallel to the longitudinal center axis 29.

In the region of top dead center OT, the crankcase interior 14 is connected to the combustion chamber 3 via transfer channels 17, 18. In the embodiment, two transfer channels 17 close to the inlet and two transfer channels 18 close to the outlet are provided, of which only one is shown in each case in the sectional illustration in FIG. 1. Each transfer channel 17 close to the inlet leads into the combustion chamber 3 by way of a transfer window 19. Each transfer channel 18 close to the outlet leads into the combustion chamber 3 by way of a transfer window 20.

In the embodiment, all the transfer channels 17 and 18 have been united and lead into the crankcase interior 14 at a common discharge opening 21. In the embodiment, the discharge opening 21 is arranged approximately beneath the outlet window 36 with a direction of view in the direction of the longitudinal center axis 29. An alternative position of one or more discharge openings 21 of the transfer channels 17 and 18 may also be advantageous.

From the combustion chamber 3 there leads an outlet window 36. The two-stroke engine 1 includes an air filter 30. The air filter 30 exhibits filter material 31. The air filter 30 has a clean chamber 32 into which air filtered by the filter material 31 enters.

The two-stroke engine 1 includes an intake channel 9 and an air channel 11. The intake channel 9 and the air channel 11 lead out of the clean chamber 32. The intake channel 9 leads out at the cylinder bore 13 by way of an intake channel opening 10. In the region of top dead center OT of the piston 5, the intake channel opening 10 is fluidically connected to the crankcase interior 14. The intake channel opening 10 is controlled by the piston 5 and opened or closed depending on the position of the piston 5.

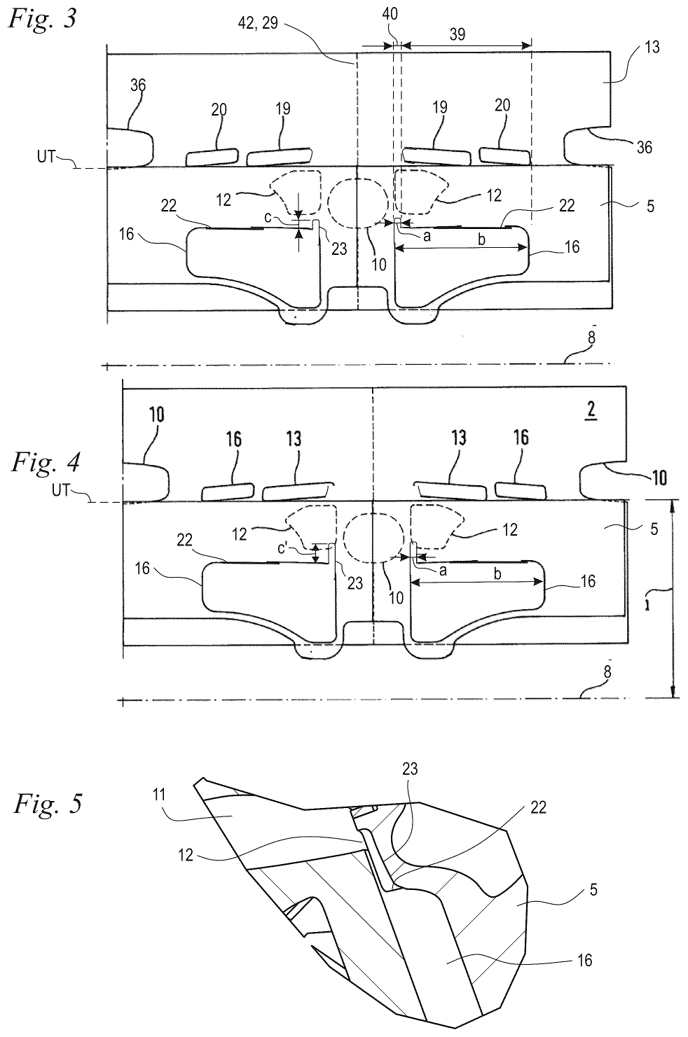

The air channel 11 leads out at the cylinder bore 13 by way of at least one air channel opening 12 (FIG. 3). In the embodiment, the air channel 11 splits into two branches, which lead out at two air channel openings 12 on both sides of the intake channel opening 10, as FIG. 3 shows.

As FIG. 1 shows, a fuel supply unit 15 is arranged on the intake channel 9, the fuel supply unit being configured to supply fuel into the intake channel 9. In the embodiment, a fuel valve is provided as the fuel supply unit 15. The fuel valve operates in particular with an overpressure of at most 1 bar, in particular at most 500 mbar above atmospheric pressure. In particular, the overpressure amounts to at most 200 mbar, in particular 50 mbar to 150 mbar above atmospheric pressure. Alternatively, the fuel supply unit 15 may also be a carburetor.

The air channel 11 and intake channel 9 are separated along a part of their length by a partition wall 26. The air channel 11 and intake channel 9 have a common channel section 33 in which the air channel 11 and intake channel 9 are jointly guided. In the embodiment, the partition wall 26 does not extend into the common channel section 33.

To control the quantity of combustion air supplied to the two-stroke engine 1, a throttle element 25 is provided. In the embodiment, the throttle element 25 is pivotably mounted. In the embodiment, the throttle element 25 is a throttle valve. The throttle element 25 is pivotably mounted in the common channel section 33 of the intake channel 9 and air channel 11. Alternatively, the throttle element can be arranged in a connecting opening of the partition wall 26 when the air channel 11 and intake channel 9 do not have a common channel section 33.

In the fully open position of the throttle element 25 that is illustrated in FIG. 1, the throttle element 25 largely separates the air channel 11 and intake channel 9 in the region of the common channel section 33. If the throttle element 25 is partially open, as is schematically indicated in FIG. 1 by a dashed line for a partial-load position of the throttle element 25, the air channel 11 and intake channel 9 are connected fluidically together in the common channel section 33. The partially open position of the throttle element 25 is indicated by the reference sign 25′ in FIG. 1.

In the embodiment, the piston 5 has two piston ring grooves 34 and 35. Alternatively, provision may be made for the piston 5 to have only one piston ring groove 34 and no piston ring groove 35. Arranged in each piston ring groove 34, 35 is a piston ring 24.

As FIG. 1 also shows, the piston 5 has a piston base 38, which delimits the combustion chamber. In the embodiment, the piston base 38 is formed in a planar manner. A non-planar configuration of the piston base 38 may also be advantageous.

As FIG. 2 shows, the piston 5 has two piston pockets 16. The piston pockets 16 are formed in particular symmetrically to a central plane 42 of the cylinder 2 (FIG. 3). The central plane 42 is the section plane in FIG. 1. The central plane 42 lies perpendicular to the rotational axis 8 of the crankshaft 7 and contains the longitudinal center axis 29 of the cylinder bore 13.

As FIG. 1 shows, the piston 5 is mounted on the connecting rod 6 in an articulated manner via a piston pin 43. The piston pin 43 is mounted in the piston 5 in two piston pin bosses 44, of which one is visible in FIG. 2. As FIG. 2 shows, the piston pin boss 44 is arranged entirely in the piston pocket 16 in the embodiment.

When the two-stroke engine 1 is in operation, during the upward stroke of the piston 5, air is supplied into the crankcase interior 14 via the intake channel 9 and the intake channel opening 10. Fuel is metered into this air via the fuel supply unit 15 such that a fuel/air mixture passes into the crankcase interior 14. In the region of top dead center, the intake channel 11 is fluidically connected to the transfer channels 17 and 18 via the air channel openings 12 and piston pockets 16 of the piston 5, which are illustrated in FIG. 2. To this end, at the cylinder bore 13, the piston pockets 16 overlap the transfer windows 19 and 20. During the upward stroke of the piston 5, negative pressure prevails in the crankcase interior 14. On account of the negative pressure in the crankcase interior 14, fuel/air mixture is drawn into the crankcase interior 14 from the intake channel 9 and air is drawn into the crankcase interior 14 from the air channel 11 via the transfer channels 17 and 18. The upward stroke of the piston is in this case the movement of the piston 5 from bottom dead center UT to top dead center OT. In the region of top dead center OT, the intake channel opening 10 to the crankcase interior 14 is fully open. The air channel 11 is fluidically connected to the transfer channels 17 and 18 via the at least one piston pocket 16 and the transfer windows 19 and 20.

During the subsequent downward stroke of the piston 5, that is, during the movement of the piston 5 from top dead center OT to bottom dead center UT, the fuel/air mixture in the crankcase interior 14 is compressed. As soon as the transfer windows 19 and 20 to the combustion chamber 3 are opened by the piston 5, first of all the air located upstream in the transfer channels 17 and 18 from the air channel 11 flows into the combustion chamber 3 and flushes exhaust gases from the previous engine cycle out of the combustion chamber 3. Via the transfer channels 17 and 18, fresh fuel/air mixture flows from the crankcase interior 14 into the combustion chamber 3. At bottom dead center UT, the air channel opening 12 and the transfer windows 19 and 20 fully overlap the piston pocket 16. Once the transfer windows 19 and 20 and the outlet window 36 have been closed by the piston 5 during the upward stroke of the piston 5, the fuel/air mixture in the combustion chamber 3 is compressed and ignited by the spark plug 28 in the region of top dead center OT. The subsequent combustion accelerates the piston 5 back in the direction of bottom dead center UT.

The position of the piston 5 is indicated as a crankshaft angle α in the present case. The crankshaft angle α denotes the rotational position of the crankshaft 7 about the rotational axis 8 of the crankshaft 7. The position, illustrated in FIG. 1, of bottom dead center UT corresponds in this case to a crankshaft angle α of 0°, and the position of the piston 5 at top dead center OT corresponds to a crankshaft angle α of 180°. Located at bottom dead center UT and at top dead center OT is a pivot axis 41, about which the connecting rod 6 is mounted pivotably on the crankshaft 7, on the longitudinal center axis 29 of the cylinder bore 13 in the embodiment.

The piston pocket 16 has an upper edge 22, as FIG. 2 shows. The upper edge 22 is that side of the piston pocket 16 that is located close to the piston base 38 and comes to overlap the transfer windows 19 and 20 during the stroke of the piston 5. The upper edge 22 in this case determines the engine timing for connecting the piston pocket 16 to the transfer windows 19 and 20. As FIG. 2 shows, a section 23 of the piston pocket 16 is arranged at the upper edge 22, the section extending from the upper edge 22 in the direction of the piston base 38.

The section 23 establishes a fluidic connection between the piston pocket and the air channel opening 12 before the upper edge 22 comes to overlap the air channel opening 12. The section 23 has a height c measured parallel to the longitudinal center axis 29. The height c is in this case measured to an upper edge 22, that is, to a region of the piston pocket which comes to overlap a transfer window 19, 20 during the piston stroke.

The section 23 exhibits a spacing d, measured parallel to the longitudinal center axis 29 (FIG. 1), from the piston ring groove 35 which is located away from the piston base 38. The spacing d is advantageously as small as possible. The spacing d amounts in particular to less than 8 mm, in particular less than 5 mm. The height c is chosen in particular to be as large as possible. The height c amounts in particular to at least 3%, in particular at least 5% of the stroke h of the piston 5.

The height c is in particular such that the piston pocket 16 exhibits a spacing d from the at least one piston ring groove 34, 35 which is greater than 1% of the piston stroke.

As FIG. 2 shows, the piston 5 has supplementary pockets 37 between the piston pockets 16 and the piston base 38. The supplementary pockets 37 are not illustrated in FIGS. 3 and 4. The supplementary pockets 37 are arranged such that are connected only to a functional opening in the cylinder bore 13 during the stroke of the piston 5. In the embodiment, the supplementary pockets 37 are connected to the transfer windows 20. The supplementary pockets 37 serve to reduce the weight of the piston 5. The supplementary pockets 37 do not influence the engine timing of the two-stroke engine 1.

FIG. 3 shows a flat projection of the cylinder bore 13 and piston 5 at bottom dead center UT of the piston 5. The piston pocket 16 has a width b. The width b is measured in the flat projection and perpendicular to the longitudinal center axis 29. The section 23 has a width a. The width a is measured in the flat projection and perpendicular to the longitudinal center axis 29. The width a and the width b are measured in the same direction at the periphery of the piston 5 and next to the cylinder bore 13. Provision is made for the width a to be smaller than the width b. The width a amounts in particular to less than 50%, in particular less than 80% of the width b. The width b is in this case the maximum width of the piston pocket 16 in the flat projection in the direction perpendicular to the longitudinal center axis 29.

The section 23 is configured and arranged such that, during the downward stroke of the piston 5, down to a crank angle α of at least 40° before bottom dead center UT, a fluidic connection exists between the piston pocket 16 and the air channel opening 12.

FIG. 4 shows an alternative embodiment variant. In the embodiment according to FIG. 4, the section 23 has a height c′. The height c′ is greater than the height c. The height c′ is chosen such that the section 23 is connected to the air channel opening 12 even at bottom dead center UT.

FIG. 5 shows the arrangement of the section 23 in a position in which the section 23 establishes a connection between the piston pocket 16 and the air channel opening 12. The upper edge 22 of the piston pocket 16 does not yet overlap the air channel opening 12 in this position of the piston 5. On account of the section 23, the piston pocket 16 remains connected to the air channel opening 12 for longer during the downward stroke of the piston 5. During the upward stroke of the piston 5, the section 23 establishes a fluidic connection of the piston pocket 16 and air channel 11 at an earlier time.

The section 23 is in the form of a groove. The section 23 forms a pilot control groove. The section 23 has a small flow cross section. The section 23 is arranged in a peripheral region 40 of the piston 5, as FIG. 3 shows. The upper edge 22 is arranged in a peripheral region 39 adjoining the latter in the peripheral direction. As FIG. 3 shows, the peripheral region 40 is laterally offset at the periphery with respect to the transfer windows 19 and 20. As a result, the section 23 comes to overlap only the air channel opening 12 during the stroke movement of the piston 5. The section 23 does not overlap any of the transfer windows 19 and 20 in any position of the piston 5.

The section 23 establishes a fluidic connection between the air channel opening 12 and piston pocket 16. The flow cross section of this fluidic connection amounts in particular to less than 50%, in particular less than 80% of the maximum flow cross section of the connection of the piston pocket 16 and air channel opening 12. The maximum flow cross section of the connection of the piston pocket 16 and air channel opening 12 is determined in particular by the flow cross section of the air channel opening 12.

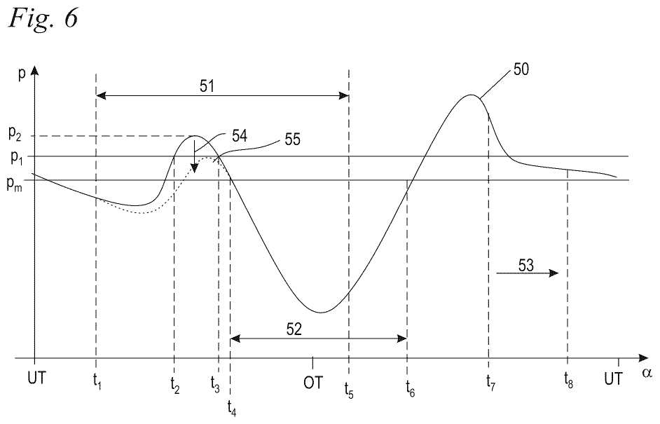

FIG. 6 schematically shows the pressure p in the intake channel 9 during a revolution of the crankshaft 7. The pressure p is illustrated as a curve 50 for a two-stroke engine not according to the disclosure. FIG. 6 also schematically indicates the mean pressure pm in the crankcase interior 14. Also indicated in FIG. 6 is a pressure p₁ which corresponds to the pressure of the fuel to be supplied. The pressure p₁ is indicated as a constant pressure in FIG. 6. The pressure p₁ can also fluctuate depending on the fuel system.

For a time period 51, the fuel supply unit 15 is opened. This is provided in particular when the fuel supply unit 15 includes a fuel valve which is opened and closed by way of a control unit of the two-stroke engine. Alternatively, the fuel supply can also take place via a carburetor and be open throughout the revolution of the crankshaft. The fuel supply can also take place via a carburetor with an electric valve, in which, by opening and closing the valve, it is possible to control the time periods at which fuel can be drawn in.

The time period 51 extends from a time t₁ to a time t₅. At the time t₁, the pressure p in the intake channel 9 is below the pressure p₁ and fuel can be supplied on account of the pressure difference. The pressure in the crankcase interior 14 increases between bottom dead center UT and top dead center OT, specifically to a pressure p₂. Between a time t₂ and a time t₃, the pressure in the crankcase interior 14 is above the fuel pressure p₁. During this time period, a fuel supply into the intake channel 9 cannot be ensured in a two-stroke engine not according to the disclosure.

At a time t₄, which is later than the time t₃, the intake channel opening 10 is opened. Thereupon, the pressure in the intake channel 9 drops significantly and is at a minimum in the region of top dead center OT, until it increases again. At a time t₅, the fuel supply unit 15 closes. At the time t₆, the intake channel opening 10 closes. In a time period 52, the intake channel opening 10 is fluidically connected to the crankcase interior 14. As the downward stroke of the piston 5 continues, the pressure in the intake channel 9 increases again and then decreases again.

In conventional two-stroke engines 1, the connection of the piston pocket 16 and air channel opening 12 is interrupted for example at the time t₇. According to the disclosure, provision is now made to shift the time at which the piston pocket 16 closes to a later time t₈, as is illustrated schematically by the arrow 53 in FIG. 6. The further engine timing of the two-stroke engine 1 remains in particular unchanged. For the description of the further engine timing of the two-stroke engine 1 according to the disclosure, reference is made to the above description of the two-stroke engine 1 not according to the disclosure.

Between the time t₇ and the time t₈, the pressure in the intake channel 9 drops. In particular, the pressure in the air channel 11 drops accordingly, for example on account of a common channel section 33 or on account of a fluidic connection of the air channel 11 and intake channel 9 in the clean chamber 32 of the air filter 30. Since the connection of the piston pocket 16 and air channel opening 12 is maintained for longer than has hitherto been customary, in order that pressure equalization can take place, the pressure level in the piston pocket 16 can be reduced. As a result, the pressure level in the intake channel 9 can be reduced after the opening of the piston pocket 16 to the air channel opening 12, which can take place for example approximately at the time t₁, as is made clear by the arrow 54 in FIG. 6. An example of a resultant pressure profile for the pressure in the intake channel 9 with a two-stroke engine 1 according to the disclosure is indicated by a dashed line in FIG. 6 with a curve 55.

In particular, the piston pocket 16 and the air channel opening 12 are configured and arranged such that the fluidic connection between the piston pocket 16 and the air channel opening 12 during the downward stroke of the piston 5 is closed at a time t₈ at which a negative pressure, that is, a pressure of 0 bar or less, prevails in the air channel 11.

In particular, the two-stroke engine 1 is configured such that the opening of the air path and the opening of the mixture path take place approximately at the same time. The connection of the two transfer channels 17 and 18 to the piston pocket 16 and the connection of the intake channel opening 10 to the crankcase interior 14 takes place in particular at crankshaft angles α that are spaced apart from one another by no more than 10° crankshaft angle α, in particular by no more than 5° crankshaft angle α. It may be advantageous for the transfer channels 17 and 18 to be connected to the piston pocket 16 before the intake channel opening 10 opens into the crankcase interior 14. Alternatively, provision may also be made for the intake channel opening 10 to be connected to the crankcase interior 14 before the transfer channels 17 and 18 are connected to the piston pocket 16.

It is understood that the foregoing description is that of the preferred embodiments of the invention and that various changes and modifications may be made thereto without departing from the spirit and scope of the invention as defined in the appended claims.

1. A two-stroke engine comprising:
a cylinder;
a piston mounted in said cylinder in a reciprocating manner, wherein said piston delimits a combustion chamber formed in said cylinder;
a crankcase defining a crankcase interior and having a crankshaft mounted rotatably therein;
said piston being configured to drive a crankshaft mounted rotatably in a crankcase in rotation;
an intake channel which leads into said crankcase interior by way of an intake channel opening;
an air channel which leads out at a cylinder bore by way of at least one air channel opening;
at least one transfer channel which leads out at said cylinder bore of said cylinder by way of at least one transfer window and which fluidically connects said crankcase interior to said combustion chamber in a region of a bottom dead center of said piston;
said piston having at least one piston pocket which connects said at least one air channel opening to said at least one transfer window at least in a region of a top dead center of said piston;
a fuel supply unit for supplying fuel into said intake channel; and,
said at least one piston pocket having at least one section configured and arranged such that, during a downward stroke of said piston, a fluidic connection between said at least one piston pocket and said at least one air channel opening exists down to a crankshaft angle (α) of at least 40° before the bottom dead center of said piston.

2. The two-stroke engine of claim 1, wherein said at least one section has a width, measured in a flat projection of said piston perpendicular to a longitudinal center axis of said cylinder bore, which amounts to less than 50% of a maximum width, measured in said flat projection of said piston perpendicular to the longitudinal center axis, of said at least one piston pocket.

3. The two-stroke engine of claim 1, wherein said at least one section has a width, measured in a flat projection of said piston perpendicular to a longitudinal center axis of said cylinder bore, which amounts to less than 80% of a maximum width, measured in said flat projection of said piston perpendicular to the longitudinal center axis, of said at least one piston pocket.

4. The two-stroke engine of claim 1, wherein said at least one section has a height, measured parallel to a longitudinal center axis, which corresponds to at least 3% of a stroke of said piston.

5. The two-stroke engine of claim 1, wherein said at least one section has a height, measured parallel to a longitudinal center axis, which corresponds to at least 5% of a stroke of said piston.

6. The two-stroke engine of claim 1, wherein said at least one section lies in a peripheral region of said piston which does not overlap any of said at least one transfer window in any position of said piston.

7. The two-stroke engine of claim 1, wherein said at least one section extends at an upper edge of said at least one piston pocket.

8. The two-stroke engine of claim 1, wherein said at least one section is a groove.

9. The two-stroke engine of claim 1, wherein a flow cross section of the fluidic connection established by said at least one section amounts to less than 50% of a maximum flow cross section of a connection of said piston pocket and said air channel opening.

10. The two-stroke engine of claim 1, wherein a flow cross section of the fluidic connection established by said at least one section amounts to less than 80% of a maximum flow cross section of a connection of said piston pocket and said air channel opening.

11. The two-stroke engine of claim 1, wherein said piston has at least one piston ring groove from which said at least one piston pocket exhibits a spacing, measured parallel to a longitudinal center axis of said cylinder bore, which is less than 8 millimeters.

12. The two-stroke engine of claim 1, wherein said piston has at least one piston ring groove from which said at least one piston pocket exhibits a spacing, measured parallel to a longitudinal center axis of said cylinder bore, which is less than 5 millimeters.
